(19) United States
(12) Patent Application Publication
(10) Pub. No.: US 2025/0353209 A1
(43) Pub. Date: Nov. 20, 2025

(54) Log Splitter

(71) Applicant: Logox LLC, Arlington, VT (US)

(72) Inventors: Jonathan Roberts, Arlington, VT (US); Austin Roberts, Hanover, NH (US); KARL MATTHIEU TIMMINS, MARATHON, NY (US); Allison Riegel, MARATHON, NY (US)

(73) Assignee: Logox LLC, Arlington, VT (US)

(21) Appl. No.: 19/206,414

(22) Filed: May 13, 2025

Related U.S. Application Data
(60) Provisional application No. 63/648,441, filed on May 16, 2024.

(51) Int. Cl. B27L 7/06

(52) U.S. Cl. CPC B27L 7/06

(57) ABSTRACT

A log splitting device includes a frame, a fixed beam with an engagement member, and a movable beam with an engagement member. The movable beam is coaxially positioned inside the fixed beam, the movable engagement member slideably positioned in a slot of the fixed beam. A drive mechanism is positioned inside the beam assembly, with a first end of the drive mechanism affixed by a horizontal pin to opposing holes in an end of the fixed beam's sidewalls, and a second end of the drive mechanism affixed by a second horizontal pin to opposing holes in an end of the movable beam's sidewalls. The device is operatively configured for the drive mechanism to create movement of the movable beam relative to the fixed beam, and capable of splitting a piece of wood.

This application claims priority, as a non-provisional of U.S. provisional application, 63/648,441 filed May 16, 2024. The entire disclosure of the parent application is incorporated herein by reference.

### BACKGROUND

The present application relates to power-assisted log splitting devices.

### SUMMARY

The disclosure provides support for a log splitting device, comprising: a frame, a fixed beam with fixed engagement member on its first end, a slot on its upper side, the fixed beam affixed to the frame, a movable beam with a movable engagement member on its second end, the movable beam coaxially positioned inside the fixed beam, the movable engagement member slideably positioned in the slot of the fixed beam, the movable beam a hollow section closed-walled tube substantially square in cross-section, a drive mechanism positioned inside the movable beam, with a first end of the drive mechanism affixed by a first horizontal pin to opposing holes in a second end of the fixed beam's sidewalls, and a second end of the drive mechanism affixed by a second horizontal pin to opposing holes in a first end of the fixed beam's sidewalls, and, the device operatively configured for the drive mechanism to create movement of the movable beam relative to the fixed beam, causing distance between the fixed engagement member and the movable engagement member to be variable.

In a first example of the system may be in which the fixed engagement member is a splitter and the movable engagement member is a pusher. In a second example of the system, optionally including the first example may be in which the fixed engagement member is a pusher and the movable engagement member is a splitter. In a third example of the system, optionally including one or both of the first and second examples may be in which the fixed engagement member is a splitter with a height of approximately 12 inches. In a fourth example of the system, optionally including one or more or each of the first through third examples may be in which the movable engagement member is a pusher with a with a height of approximately 12 inches. In a fifth example of the system, optionally including one or more or each of the first through fourth examples may be in which a pushing surface of the movable engagement member includes a pattern of concentric groves.

In a sixth example of the system, optionally including one or more or each of the first through fifth examples may be in which the drive mechanism is a hydraulic piston-cylinder assembly. In a seventh example of the system, optionally including one or more or each of the first through sixth examples may be in which the movable beam is configured with a sliding clearance fit to be movable inside of and relative to the fixed beam. In an eighth example of the system, optionally including one or more or each of the first through seventh examples may be in which a horizontal orientation of the first and second pin minimizes bending stress imparted to the drive mechanism by allowing rotation around each pin under loads applied to the log splitting device when splitting a log. In a ninth example of the system, optionally including one or more or each of the first through eighth examples may be in which the fixed beam contains at least one pin hole near its first end, a stroke-limiting pin removably mounted in the pin hole, wherein the pin limits a travel distance of the movable beam relative to the fixed beam.

In a tenth example of the system, optionally including one or more or each of the first through ninth examples configured so the movable beam travels 26 inches with no stroke-limiting pin in place, the movable beam travels 18 inches with the stroke-limiting pin in a first pin hole, the movable beam travels 14 inches with the stroke-limiting pin in a second pin hole. In an eleventh example of the system, optionally including one or more or each of the first through tenth examples may be in which a top surface of the fixed beam forms a portion of a planar work surface, the planar work surface affixed to the frame. In a twelfth example of the system, optionally including one or more or each of the first through eleventh examples may be in which the frame and planar work surface are attached to a wheel assembly and a trailer hitch, allowing the device to be mobile. In a thirteenth example of the system, optionally including one or more or each of the first through twelfth examples may be in which the planar work surface includes a foldable extension. In a fourteenth example of the system, optionally including one or more or each of the first through thirteenth examples may be in which the planar work surface has dimensions of approximately 36 inches wide and 42 inches long.

### BRIEF DESCRIPTION OF THE DRAWINGS

FIG. 1 is an upper perspective view of a log splitting device;

FIG. 2 is a top view of a log splitting device;

FIG. 3 is an upper perspective view of a log splitting device;

FIG. 4 is a right side view of a log splitting device;

FIG. 5 is a front view of a log splitting device;

FIG. 6 is a left side view of a log splitting device;

FIG. 7 is an rear view of a log splitting device;

FIG. 8 is a bottom view of a log splitting device;

FIG. 9 is a front perspective view of a fixed beam;

FIG. 10 is a front perspective view of a movable beam;

FIG. 11 is a front perspective view of a movable beam positioned inside a fixed beam;

FIG. 12 is a rear perspective view of a movable beam positioned inside a fixed beam;

FIG. 13 is a front view of a movable beam positioned inside a fixed beam;

FIG. 14 is a rear view of a movable beam positioned inside a fixed beam;

FIG. 15 is a front perspective view of a piston-cylinder assembly;

FIG. 16 is a perspective view of a stroke-limiting mechanism installed on a beam assembly;

FIG. 17 is a perspective view of a stroke-limiting mechanism installed on a beam assembly;

FIG. 18 is a detail of a stroke-limiting mechanism;

FIG. 19 is a detail in transparent view of a movable beam positioned inside a fixed beam;

FIG. 20 is detail of a beam assembly in fully extended position, including stroke-limiting mechanism installed;

FIG. 21 is detail of a beam assembly in fully extended position, without a stroke-limiting mechanism installed;

### DETAILED DESCRIPTION

The specific embodiments given in the drawings and following description do not limit the disclosure. On the contrary, they provide the foundation for one of ordinary skill to discern the alternative forms, equivalents, and modifications that are contemplated by the inventors and encompassed in the scope of present claims herein and future claims which may be filed.

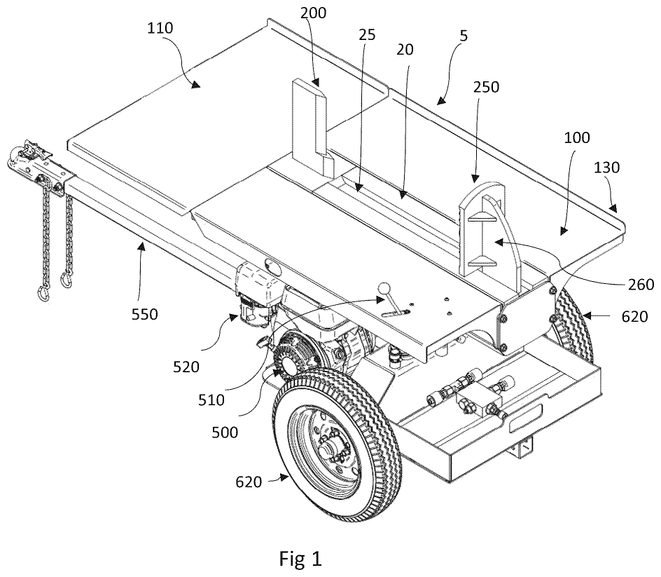

FIG. 1 shows upper perspective view of a log splitting device 5. The device may include a substantially planar work surface 100. Extension 110 may be attached to 100 with hinges or other suitable mechanisms, such that extension 110 may fold into an approximately perpendicular position to that of work surface 100. This may allow a larger work surface when the extension 110 is in its extended position, while allowing overall log splitting device 5 to be more compact for storage, shipping, etc. when extension 110 is in its folded position. There may be a lip 130 on one or more sides of work surface 100, to inhibit a log from unwantedly rolling off the work surface.

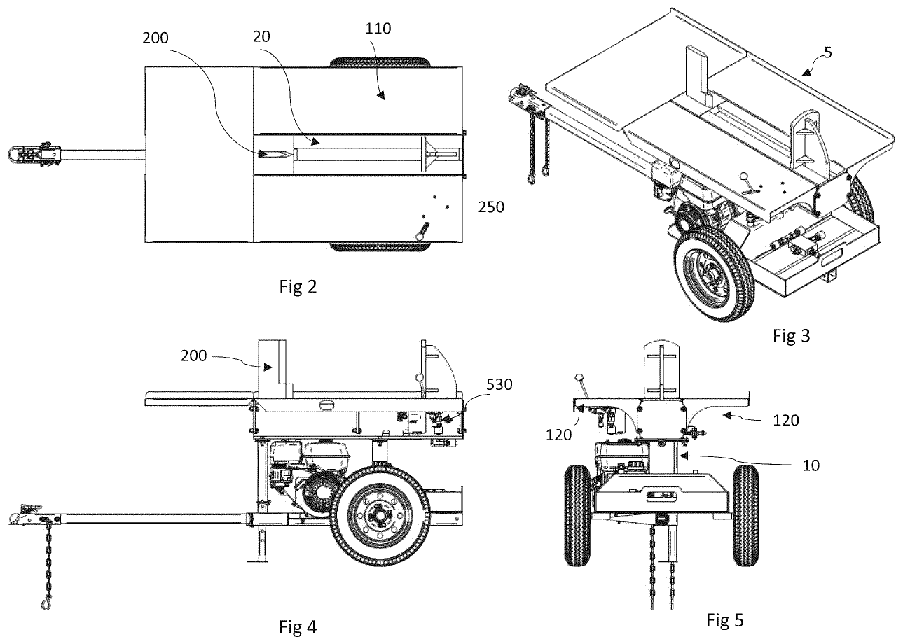

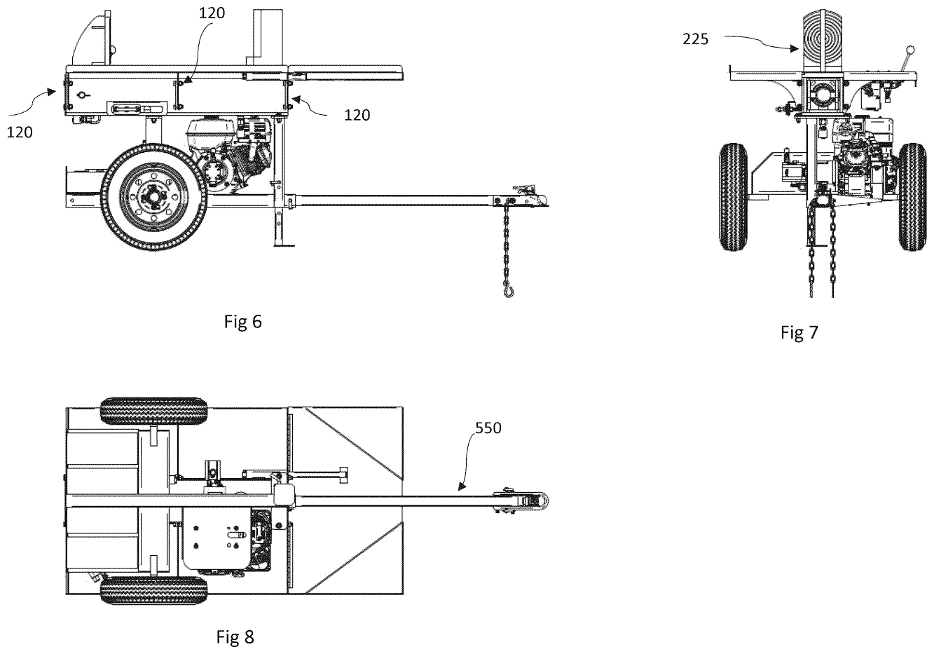

Additional views of the overall log splitting device 5 are seen in FIGS. 2-8. At least one brace 120 may be present to create additional strength and stiffness. Various components of log splitting device 5 mount directly or indirectly to frame 10, such as work surface 100, motor 500, hitch extension 550, wheels 620, drive mechanism 40, and other ancillary components.

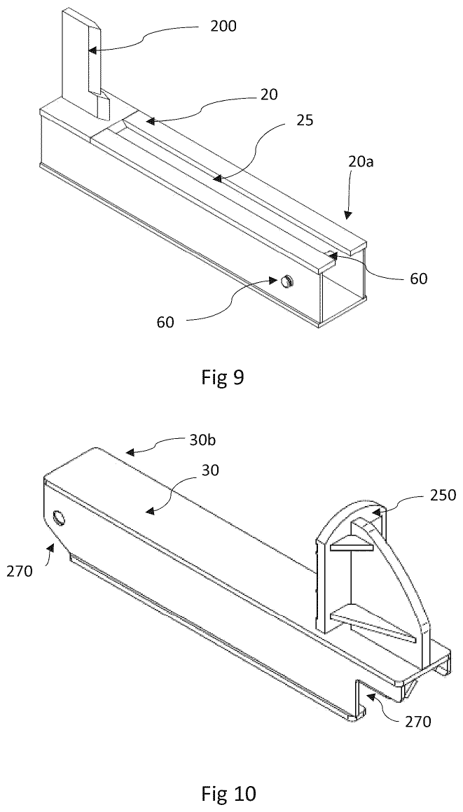

FIG. 9 shows a front perspective view of a fixed beam 20, also called a first beam, or tubular beam, which includes slot 25. Fixed engagement member 200 is positioned at one end of fixed beam 20. In one embodiment, fixed engagement member 200 comprises a wedged splitter, which penetrates the end of a log and separates in log into multiple pieces in use, as will be further detailed. Fixed beam 20 may attach to frame 10, using suitable methods such as fasteners, welding, etc. Fixed beam 20 is substantially rectangular in cross-section, with the exception of the portion taken by slot 25, and may be described as a tubular beam.

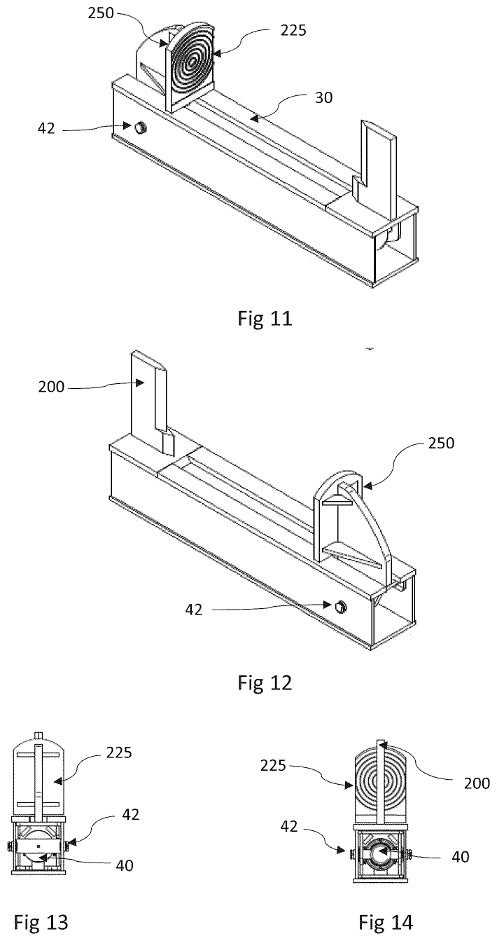

FIG. 10 shows a perspective view of movable beam 30, also called a second beam. In FIGS. 11 through 14, movable beam 30 is positioned inside fixed beam 20, in a coaxial orientation. FIGS. 11 and 12 show perspective views of the beam coaxially positioned together, or nested together. FIGS. 13 and 14 show front and back views thereof. Movable beam 30 is substantially rectangular in cross-section, with clearance notches 270 configured into each end as shown, and may be described as a tubular beam. Further, it may be a closed-walled tubular beam—that is for much of its length, movable beam 30 includes four walls joined together to form a continuous square, without slots or open sections along its length. This closed-walled structure may provide desirable properties such as added strength and stiffness, which help reduce unwanted flex in the system while in use, compared to a non-continuous member such as a C-channel shape.

Movable engagement member 250, which may include reinforcing members 260, is positioned on one end of movable beam 30, and is capable of moving back-and-forth in slot 25. When engaged together coaxially, movable beam 30 slides relative to fixed beam 20, and thus is movable relative to the overall fixed portions of log splitting device 5. Such movement drives movable engagement member 250 closer to fixed engagement member 200. Thus when a log is placed in the space between the two members, a log is split into two or more pieces as the machine is activated by use of a drive mechanism, which will be further detailed.

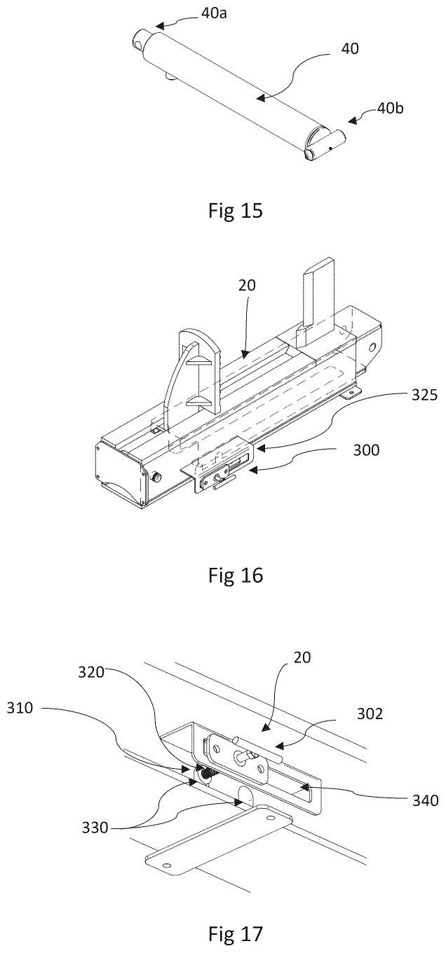

Drive mechanism 40 is shown in FIG. 15. In one embodiment, drive mechanism 40 is operated hydraulically, with related components such as hydraulic pump 520, valve 530, and controls 510, with power by motor 500, as shown in FIGS. 1-8 Such hydraulic driving systems are known in the art, and thus won't be fully detailed here. Of course, other suitable types of systems, such as but not limited to electric systems, may be used to drive the piston-cylinder assembly. Drive mechanism 40 is positioned coaxially to, inside, movable beam 30.

A first end 40a of drive mechanism 40 is attached to a second end 20a of fixed beam 20 (or alternately, first end 40a is attached to adjacent frame structure to which fixed beam 20 is attached), and a second end 40b of drive mechanism 40 is attached to a first end 30a of movable beam 30. Thus the actuation of drive mechanism 40 creates relative movement between the two beams. A pin 42 affixes first end 40a to a second end 20a of fixed beam 20, with a similar style pin 42 affixing second end 40b to first end 30a of movable beam 30. In both cases, pins 42 may be oriented horizontally and through holes 60 in the sidewalls of fixed beam 20 and movable beam 30 respectively. A fastener such as a cotter pin may be used to secure each attachment pin in place.

The coaxial orientation of the two tubular beams creates a structure well-suited to resisting the bending forces created by the actuation of the device splitting a log. Through the full range of travel of movable engagement member 250 relative to fixed engagement member 200 during log splitting, the first beam and the movable beam, as well as the piston-cylinder assembly, remain coaxial, and such that a log is typically positioned above a beam-inside-a beam configuration. In one embodiment, the dimensions and finished surface of the two beams are such that the two beams are engaged with a sliding clearance fit, without the use of bearings, bushings, or similar mechanisms. At least one grease port may be included to provide lubrication between the two beams as part of the sliding clearance fit configuration. Other types of clearance fits may be used, such as those which include bearings, bushings, and the like.

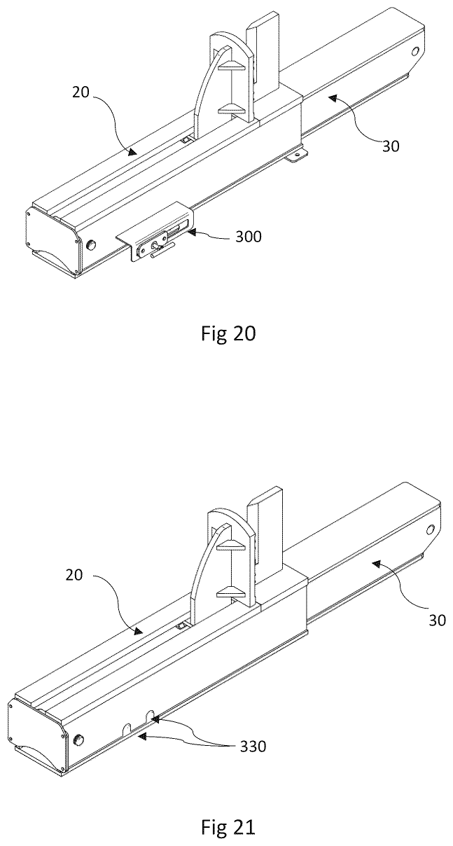

The beam-inside-a-beam configuration with a sliding clearance fit effectively provides the strength and stiffness of a double-walled tubular beam (one tubular beam inside another tubular beam) when in a retracted position, and is located in an area of high stress in the log splitting device. This configuration minimizes mechanical strain/deflection created by the process of a log being split between the two engagement members. By positioning the attachment pins in a horizontal orientation, any beam deflection that does occur does not translate to the piston-cylinder assembly, as the horizontal attachment pins allow slight joint rotation. This further minimizes deflection of the drive mechanism under load, thereby promoting increased service life by reducing stresses from bending loads to internal hydraulic seals and related components. In some embodiments, such joint rotation is not created, and the drive mechanism serves as a structural member. FIG. 19 shows a transparent view of movable beam 30 inside of fixed beam 20. FIG. 20 shows the fixed beam 20 and the movable beam 30, together, which may be referred to as a beam assembly, in a fully extended position, with stroke-limiting mechanism 300 installed. FIG. 21 is as in FIG. 20, but without with stroke-limiting mechanism 300, to show pin holes 330 in first beam 20, which are obscured in FIG. 20.

The tubular beam construction provides sufficient strength and stiffness required to make one or both of fixed engagement member 200 and movable engagement member 250 relatively tall. The allowable tallness of the engagement members is directly related the strength and stiffness of the overall device, in order to not exceed calculated loading. That is, height of each engagement member is the effective length of a lever arm that applies force from the mounting point of the engagement member to the overall device, thus a taller engagement member imparts higher loading to its mount that a shorter engagement member. Tall engagement members may be considered desirable, as they allow splitting logs of corresponding larger diameter. In one embodiment, the height of at least one of the engagement mechanisms is approximately 12 inches, which is a range of about 11 inches to 13 inches, with a work surface measuring approximately 36 inches wide by 42 inches long, which is a range of about 34 inches to 38 inches wide and 40 inches to 44 inches long.

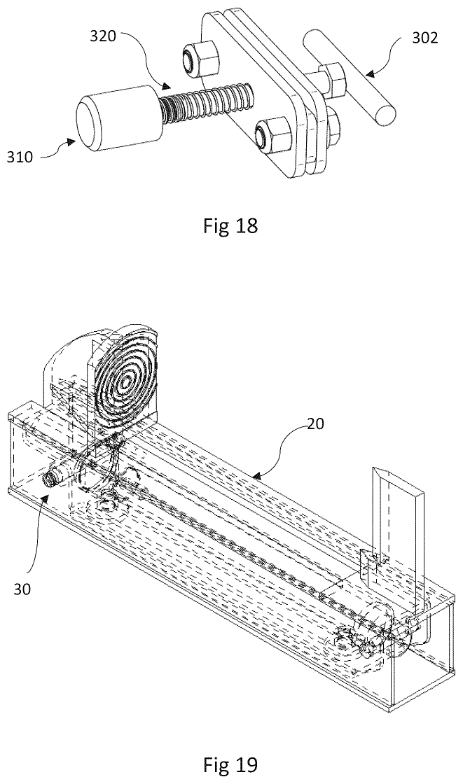

FIGS. 16-18 show details of a stroke-limiting mechanism 300, comprising a handle 302, pin 310, spring 320, and bracket 325. When pin 310 is in one of the at least one pin holes 330 of fixed beam 20, pin 310 is positioned to protrude into the inner portion of the first tubular beam 20, thereby limiting the stroke of the drive mechanism. This creates a stop for the end of movable beam 30 to abut. Bracket 325 may be affixed to fixed beam 20 by suitable means such as welding or via fasteners, and may include an adjustment slot 340, allowing fine-tuning of the position of pin 310 relative to pin holes 330. Pin 310 may be positioned between pin holes 330, and against the side or end of fixed beam 20—in such a position, pin 310 does not protrude into the inner portion of the first tubular beam 20, and therefore does not act as a stroke limiter.

In one embodiment, the stroke limiter allows an operator to choose from three stroke lengths: 26″ full stroke, 14″ short stroke, and 18″ mid stroke. When pin 310 acts as a stroke limiter by extending in either of the two pin holes 330, its stops the motion of movable beam 30, causing the hydraulic system pressure detent to kick out on the valve. This can dramatically reduce the operation time per cycle hence increasing the number of logs that can be split per hour, compared to using a long stroke to split a short piece of wood.

As seen in FIG. 11 and other FIGS., movable engagement member 250 may include grooves 225 on its otherwise planar surface. In one embodiment, grooves 225 are configured in a pattern of concentric rings, approximately circular. Depending on the dimensions of the groves 225 relative to the area of engagement member 250, some rings may be partial, as shown. Grooves 225 serve to create friction between an engagement member and the end of a log to be split. Often, the end of log is not cut exactly perpendicular to the sides of the log, thereby causing the end of the log to not face the engagement member squarely and completely. Grooves 225 penetrate the end of a log, thereby inhibiting a log from slipping out from the splitter device.

A circular pattern in particular provides friction through a 360 degree orientation, which is advantageous compared to a pattern of square ridges in only four discrete directions. In various embodiments, grooves 225 may range from ⅛″ deep to 1″ deep.

The device may be operated by using controls 510 to actuate the system and cause the drive mechanism to move. With the drive mechanism placing the movable engagement member 250 in a retracted position, a user would place a log in position between the movable engagement member 250 and the fixed engagement member 200. The user would activate the control, causing the drive mechanism to move the movable engagement member 250 closer to the fixed engagement member 200, thereby separating the log into two (or more) pieces.

In this disclosure, fixed engagement member 200 is shown and described as a splitter, with movable second engagement member 250 as a pusher with a grooved surface. Of course, the orientation of these two components may be switched, with the fixed engagement member having a planar surface (and optionally including grooves), and the movable engagement member comprising a splitter. The system described herein may use a hydraulic piston-cylinder system as a drive mechanism, including a pump and motor assembly. Other types of drive mechanisms may be used that are capable of driving a splitting wedge through a log. Examples of alternative drive mechanisms include, but are not limited to, wheel drive mechanisms, screw or worm drives, and the like.

Numerous alternative forms, equivalents, and modifications will become apparent to those skilled in the art once the above disclosure is fully appreciated. It is intended that the claims of the present patent application will be interpreted to embrace all such alternative forms, equivalents, and modifications where applicable.

We claim:

1. A log splitting device, comprising:
a frame;
a fixed beam with fixed engagement member on its first end, a slot on its upper side, the fixed beam affixed to the frame;
a movable beam with a movable engagement member on its second end, the movable beam coaxially positioned inside the fixed beam, the movable engagement member slideably positioned in the slot of the fixed beam, the movable beam a hollow section closed-walled tube substantially square in cross-section;
a drive mechanism positioned inside the movable beam, with a first end of the drive mechanism affixed by a first horizontal pin to opposing holes in a second end of the fixed beam's sidewalls, and a second end of the drive mechanism affixed by a second horizontal pin to opposing holes in a first end of the fixed beam's sidewalls, and;
the device operatively configured for the drive mechanism to create movement of the movable beam relative to the fixed beam, causing distance between the fixed engagement member and the movable engagement member to be variable.

2. The device of claim 1, in which the fixed engagement member is a splitter and the movable engagement member is a pusher.

3. The device of claim 1, in which the fixed engagement member is a pusher and the movable engagement member is a splitter.

4. The device of claim 1, in which the fixed engagement member is a splitter with a height of approximately 12 inches.

5. The device of claim 1, in which the movable engagement member is a pusher with a with a height of approximately 12 inches.

6. The device of claim 1, in which a pushing surface of the movable engagement member includes a pattern of concentric groves.

7. The device of claim 1, in which the drive mechanism is a hydraulic piston-cylinder assembly connected to a hydraulic system including a pump, valve, motor, and controls.

8. The device of claim 1 in which the movable beam is configured with a sliding clearance fit to be movable inside of and relative to the fixed beam.

9. The device of claim 1, in which a horizontal orientation of the first and second pins minimizes bending stress imparted to the drive mechanism by allowing rotation around each pin under loads applied to the log splitting device when splitting a log.

10. The device of claim 1 in which the fixed beam contains at least one pin hole near its first end, a stroke-limiting pin removably mounted in the pin hole, wherein the pin limits a travel distance of the movable beam relative to the fixed beam.

11. The device of claim 10, configured so the movable beam travels 26 inches with no stroke-limiting pin in place, the movable beam travels 18 inches with the stroke-limiting pin in a first pin hole, the movable beam travels 14 inches with the stroke-limiting pin in a second pin hole.

12. The device of claim 1, in which a top surface of the fixed beam forms a portion of a planar work surface, the planar work surface affixed to the frame.

13. The device of claim 12 in which the frame and planar work surface are attached to a wheel assembly and a trailer hitch, allowing the device to be mobile.

14. The device of claim 12, in which the planar work surface includes a foldable extension.

15. The device of claim 12, in which the planar work surface has dimensions of approximately 36 inches wide and 42 inches long.
